(19) United States
(12) Patent Application Publication
(10) Pub. No.: US 2006/0053161 A1
(43) Pub. Date: Mar. 9, 2006

(54) Method to organize and track information according to chronological and priority order

(76) Inventor: John Chung Lee, Alhambra, CA (US)

Correspondence Address: JOHN J. ELNITSKI, JR., 225 A SNOWBIRD LANE, BELLEFONTE, PA, 16823, US

(21) Appl. No.: 10/516,722

(22) PCT Filed: Jul. 12, 2002
(86) PCT No.: PCT/US02/22136

§ 371 Date: Dec. 2, 2004

(51) Int. Cl. G06F 17/00

(52) U.S. Cl. 707/104.1

(57) ABSTRACT

The method to organize and track information is a method to track information such as a person's name, telephone number, follow up dates, priority, and task number. A person may use the method to track information and to easily and quickly store, retrieve, and sort the information (FIG. 1). In the preferred embodiment, the method to organize and track information can sort the information base on the follow up date, priority, and task number and decisions base on the information sorted in accordance with the criteria desired by the person.

### BACKGROUND-FIELD OF INVENTION

The present invention relates generally to a method to organize and track information such as things-to-do. More particularly, the present invention relates to a method to organize things-to-do according to follow up dates and priorities.

### BACKGROUND-DESCRIPTION OF RELATED ART

Every person must keep track of a long list of things-to-do in the modern society. These things-to-do may comprise of information such as tasks that must be performed, a telephone call that must be made, and customers or clients that needs follow-up contacts. These information must be readily and easily organized and be easily retrieved and sorted in the desired fashion to be useful.

Currently, there are no convenient methods to store and retrieve these information in a sorted fashion. The most widely used method is to either utilize a spreadsheet or a database software to store, retrieve, and sort the information. However, although the generic multi-purpose spreadsheet or database software may perform these functions adequately, they do not provide nearly the level of ease and usefulness of the present invention. The spreadsheet or the database software are complicated and requires a steep learning curve before the user can use the software proficiently to retrieve the information in the format he/she desires.

### SUMMARY OF THE INVENTION

The present invention is a method to track information such as a person or a company's name, telephone number, follow up dates, priority, and task number. A person may use the present invention to easily and quickly store, track, retrieve, and sort the information.

In the preferred embodiment, the method to organize and track information sort the information base on the follow up date, priority, and task number and allow a person to make critical decisions base on the information sorted in accordance with the criteria desired by the person.

### BRIEF DESCRIPTION OF THE DRAWINGS

FIG. 1 is a flowchart that shows the method to organize and track information such as things-to-do.

### DETAILED DESCRIPTION OF THE PREFERRED EMBODIMENT

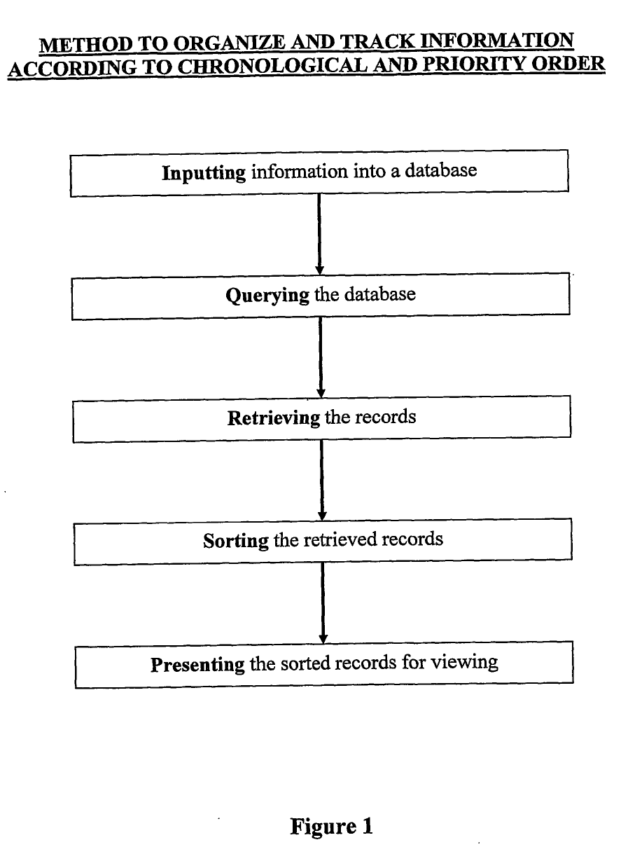

The preferred embodiment of the method to organize and track information is shown in FIG. 1 and comprises the steps of inputting information, such as a person or a company's name, telephone number, follow up dates, priority, and task number, into appropriate fields in a database, querying the database, retrieving the records that match the query criteria, sorting the retrieved records based on the follow up date, priority, and task number, and presenting the sorted records for viewing. This method allows a person to make efficient critical decisions based on the information presented.

Information, such as a person or a company's name, telephone number, follow up dates, and priority, is gathered and the information is assigned a sequential task number. These information are entered into appropriate fields in a record in the database. The records in the database may be sorted using any field as the index. The database may also be sorted using one field as the primary index and another field as the secondary index to further organize and sort the records. In the preferred embodiment, the follow up date field is used as the primary index and the priority field is used as the secondary index. The task number field is used as the third index to avoid duplicate keys which may cause key violations in the database. The task number is assigned permanently to a record, and when a record is deleted the task number field for the remaining records will not be renumbered. When a new record is added, the new record will be assigned the next available task number.

The user may query the database to obtain the information he/she needs. One method of query may be locating records with follow up dates prior to the date of query or a particular desired date. This query will allow the user to locate past due follow up dates that require immediate action. The user may also query the database for specific information in any particular field in the records. Another useful query that the user may perform is to locate records with follow up dates between two specified dates. This query will allow the user to plan his/her schedules and the necessary actions that must be taken within a specified period of time.

After the matching records are located within the database, the records are retrieved and sorted in accordance with the requirements of the user. In the preferred embodiment of the present invention, the final sorted records are presented to the user on a video screen for viewing. The user may then make efficient critical decisions based on the information presented.

Although the description above contains many specificities, these should not be construed as limiting the scope of the invention but as merely providing illustrations of some of the presently preferred embodiments of this invention. Thus the scope of the invention should be determined by the appended claims and their legal equivalents, rather than by the examples given.

What is claimed is:

1. A method to organize and track information such as things-to-do comprising the steps of:
inputting the information, such as a person or a company's name, telephone number, follow up dates, priority, and task number, into appropriate fields in a database;
querying the database base on the current date;
retrieving the records with follow up dates earlier than the current date;
sorting the retrieved records based on and in the order of the follow up date, priority, and task number; and
presenting the sorted records for viewing;
wherein a person may make efficient critical decisions based on the information presented.

2. A method to organize and track information such as things-to-do as in claim 1 wherein the retrieved records are sorted based on and in the order of priority, follow-up date, and task number.

3. A method to organize and track information such as things-to-do comprising the steps of:
inputting information, such as a person or a company's name, telephone number, follow up dates, priority, and task number, into appropriate fields in a database;
querying the database base on a desired field;
retrieving the records with fields that match the queried criteria;
sorting the retrieved records based on and in the order of the follow up date, priority, and task number; and
presenting the sorted records for viewing;
wherein a person may make efficient critical decisions based on the information presented.

4. A method to organize and track information such as things-to-do as in claim 3 wherein the retrieved records are sorted based on and in the order of priority, follow-up date, and task number.

5. A method to organize and track information such as things-to-do comprising the steps of:
inputting information, such as a person or a company's name, telephone number, follow up dates, priority, and task number, into appropriate fields in a database;
querying the database for records with follow up dates between two desired dates;
retrieving the records with follow up date field that match the queried criteria;
sorting the retrieved records based on and in the order of the follow up date, priority, and task number; and
presenting the sorted records for viewing;
wherein a person may make efficient critical decisions based on the information presented.

6. A method to organize and track information such as things-to-do as in claim 5 wherein the retrieved records are sorted based on and in the order of priority, follow-up date, and task number.
